(19) United States
(12) Patent Application Publication
(10) Pub. No.: US 2024/0019172 A1
(43) Pub. Date: Jan. 18, 2024

(54) Air Blowing And Heating Device And Method Of Use

(71) Applicant: Verlande Regis, Brighton, MA (US)

(72) Inventor: Verlande Regis, Brighton, MA (US)

(21) Appl. No.: 17/864,037

(22) Filed: Jul. 13, 2022

(51) Int. Cl. F24H 3/04; E01H 5/10; E01H 1/08

(52) U.S. Cl. CPC F24H 3/0423; E01H 5/106; E01H 1/0809

(57) ABSTRACT

An air blowing and heating device for generating and selectively heating forced air includes a housing, which is tubular and open ended, thus defining an intake port and an outlet port. A blower and a heater are attached to and are positioned in the housing. The blower selectively forces air through the outlet port and the heater selectively heats the air. A battery is operationally engaged to the blower and the heater. A switch is attached to the housing and is operationally engaged to the battery, the heater, and the blower. The switch selectively actuates the blower to generate unheated forced air, enabling a user to blow debris, such as leaves, dust, and the like. The switch also can selectively actuate the blower and the heater concurrently to generate heated forced air, enabling the user to blow and to melt sleet, snow, ice, and the like.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to air blowing devices and more particularly pertains to a new air blowing device for generating and selectively heating forced air. The present invention discloses an air blowing device that can selectively generated unheated forced air and heated forced air.

### (2) Description of Related Art Including Information Disclosed Under 37 CFR 1.97 and 1.98

The prior art relates to air blowing devices. The prior art includes several blower and heater combinations that are used to melt snow and ice, which may be powered by one or more of power cords, batteries, and gas, and which may have implements, such as brushes and scrapers, attached to their blower housings. What is lacking in the prior art is an air blowing device comprising a housing to which a rechargeable battery is selectively attachable. Further lacking is a switch, which selectively actuates a blower to generate unheated forced air and the blower and a heater concurrently to generate heated forced air. Also lacking in the prior art is a controller allowing for control of the temperature of the heated forced air.

### BRIEF SUMMARY OF THE INVENTION

An embodiment of the disclosure meets the needs presented above by generally comprising a housing, which is tubular and open ended, thus defining an intake port and an outlet port. A blower and a heater are attached to and are positioned in the housing. The blower is configured to selectively force air through the outlet port and the heater is configured to selectively heat the air that passes through the housing. A battery is selectively attachable to the housing so that the battery is operationally engaged to the blower and the heater. A switch is attached to the housing and is operationally engaged to the battery, the heater, and the blower. The switch is configured to be switched to selectively actuate the blower to generate unheated forced air, enabling a user to blow debris, such as leaves, dust, and the like. The switch also is configured to be switched to selectively actuate the blower and the heater concurrently to generate heated forced air, enabling the user to blow and to melt sleet, snow, ice, and the like.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an air blowing and heating device according to an embodiment of the disclosure.

FIG. 2 is an isometric perspective view of an embodiment of the disclosure.

FIG. 3 is a side view of an embodiment of the disclosure.

FIG. 4 is a rear view of an embodiment of the disclosure.

FIG. 5 is a front view of an embodiment of the disclosure.

FIG. 6 is a cross-sectional view of an embodiment of the disclosure.

FIG. 7 is a block diagram of an embodiment of the disclosure.

FIG. 8 is an in-use view of an embodiment of the disclosure.

FIG. 9 is a flow diagram for a method utilizing an embodiment of the disclosure.

### DETAILED DESCRIPTION OF THE INVENTION

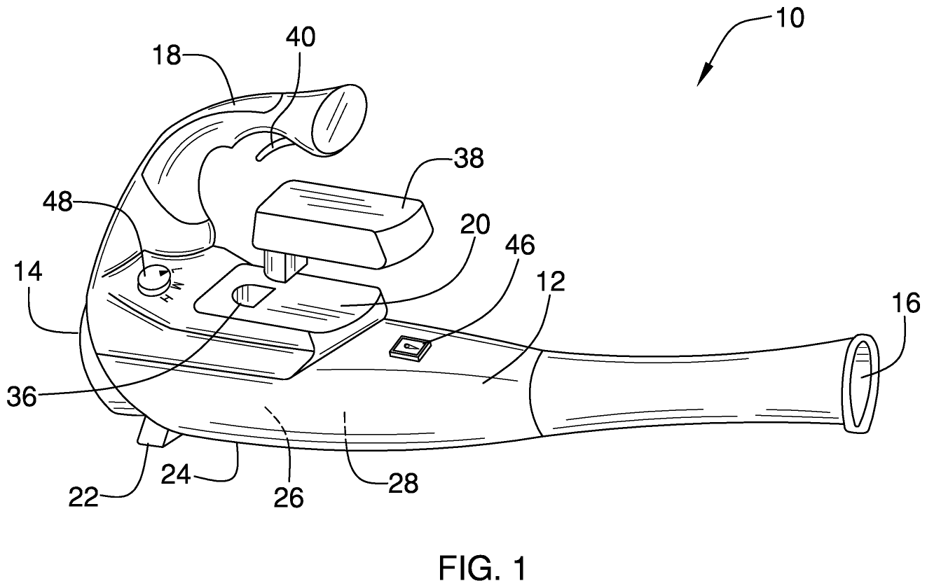

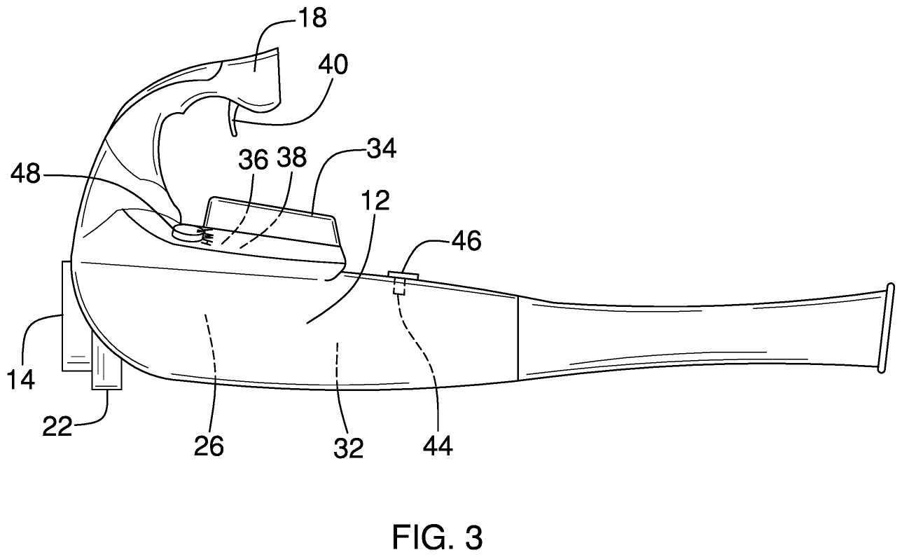

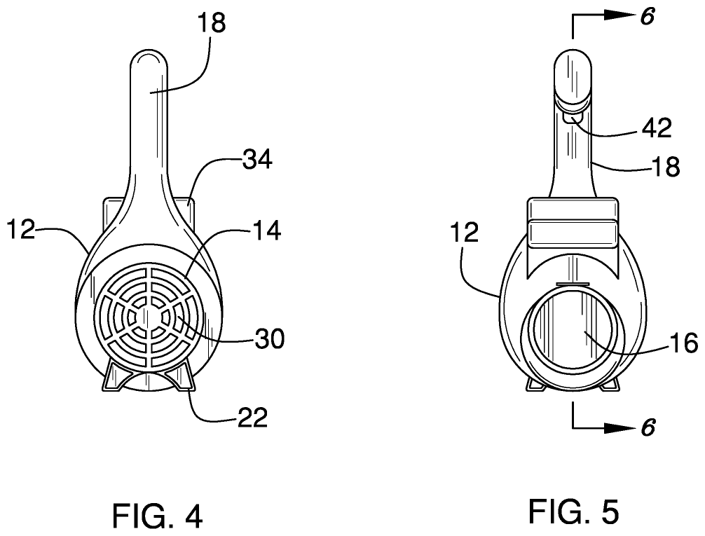

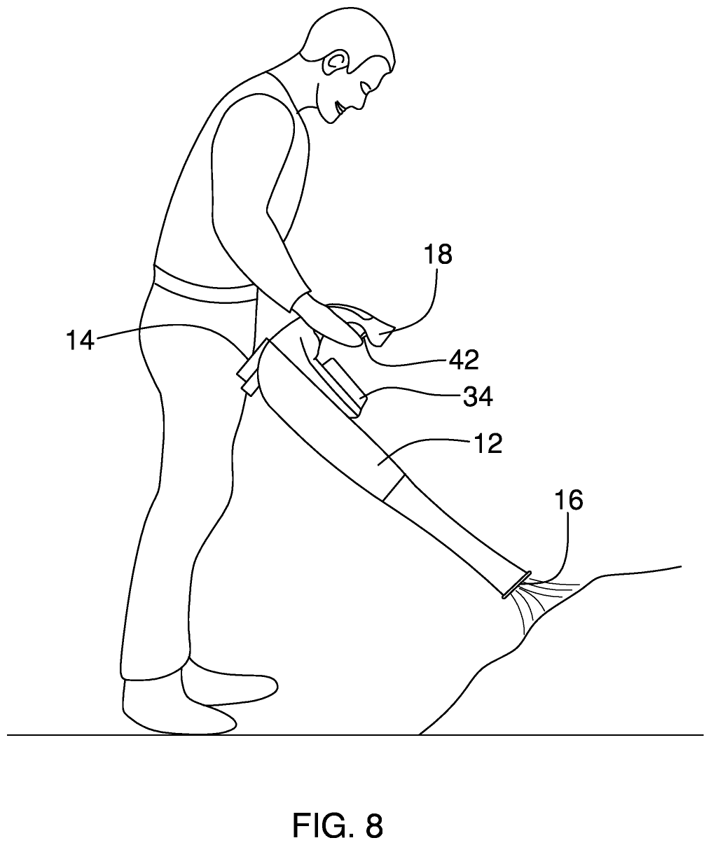

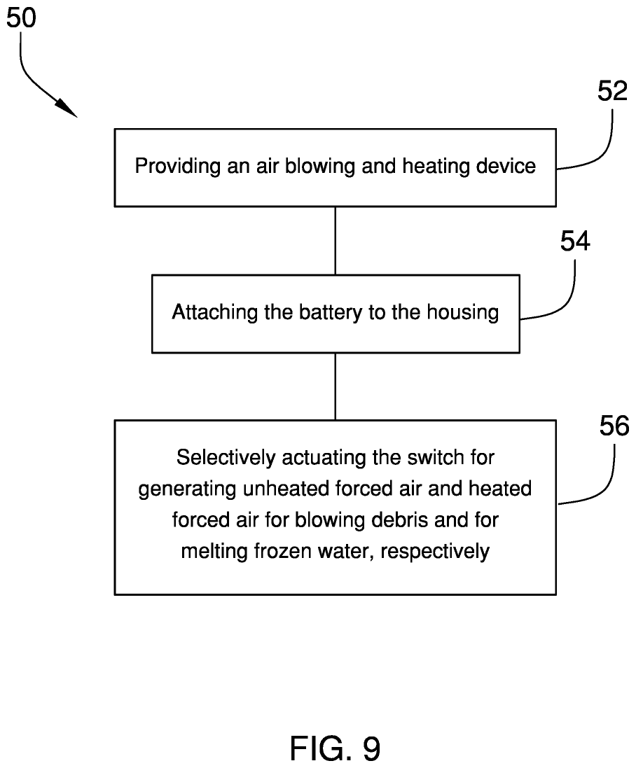

With reference now to the drawings, and in particular to FIGS. 1 through 9 thereof, a new air blowing device embodying the principles and concepts of an embodiment of the disclosure and generally designated by the reference numeral 10 will be described.

As best illustrated in FIGS. 1 through 9, the air blowing and heating device 10 generally comprises a housing 12, which is tubular and open ended, thus defining an intake port 14 and an outlet port 16. A handle 18 is attached to a top 20 of the housing 12, proximate to the intake port 14, and extends arcuately from the housing 12 toward the outlet port 16. A foot 22, which is attached to a bottom 24 of the housing 12 proximate to the intake port 14, is configured to stabilize the housing 12 on a surface.

A blower 26 and a heater 28 are attached to and are positioned in the housing 12. The blower 26 is configured to selectively force air through the outlet port 16 and the heater 28 is configured to selectively heat the air that passes through the housing 12. A grate 30, which is attached to the housing 12 and which extends over the intake port 14, is configured to exclude objects from the air that enters through the intake port 14. The heater 28 may comprise a gridded heating element 32, or heating elements of other configurations, such as, but not limited to, spiral heating elements, heating elements extending linearly along the housing 12, and the like.

A battery 34 is selectively attachable to the housing 12 so that the battery 34 is operationally engaged to the blower 26 and the heater 28. A receptacle 36 is attached to the housing 12 and a plug 38 is attached to the battery 34. The plug 38 is complementary to the receptacle 36 so that the plug 38 is positioned for insertion into the receptacle 36 to attach the battery 34 to the housing 12 and to operationally engage the battery 34 to the blower 26 and the heater 28. As shown in FIG. 1, the receptacle 36 is positioned on the top 20 of the housing 12 proximate to the handle 18. Thus positioned, the mass of the battery 34 is supported by the housing 12 and the plug 38 is less likely to inadvertently detach from the receptacle 36. The battery 34 is rechargeable and is also anticipated by the present invention to be integral to housing 12 and to be rechargeable by means of a charging port and a charging cord (not shown).

A switch 40 is attached to the housing 12 and is operationally engaged to the battery 34, the heater 28, and the blower 26. The switch 40 is configured to be switched to selectively actuate the blower 26 to generate unheated forced air, enabling a user to blow debris, such as leaves, dust, and the like. The switch 40 also is configured to be switched to selectively actuate the blower 26 and the heater 28 concurrently to generate heated forced air, enabling the user to blow and to melt sleet, snow, ice, and the like.

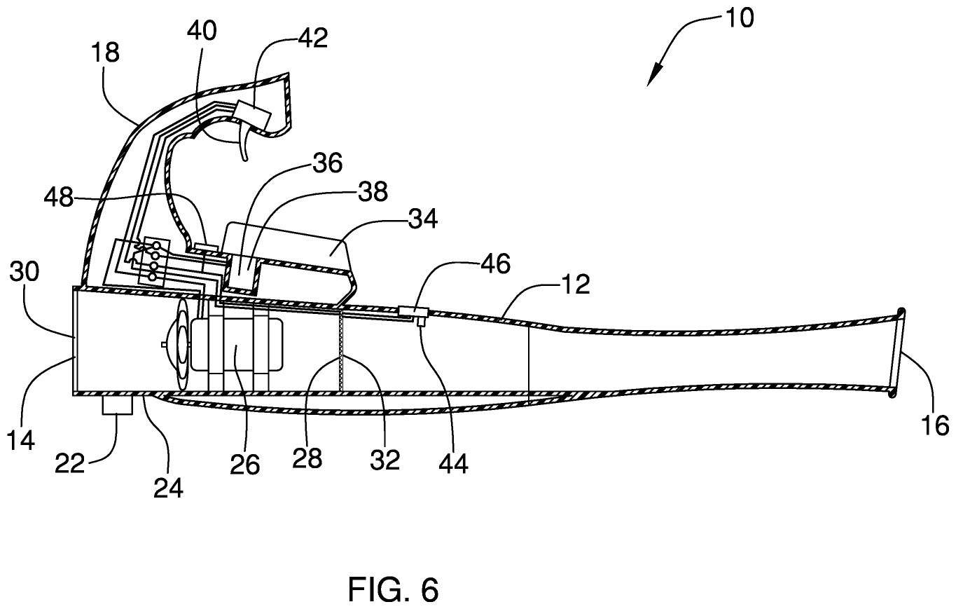

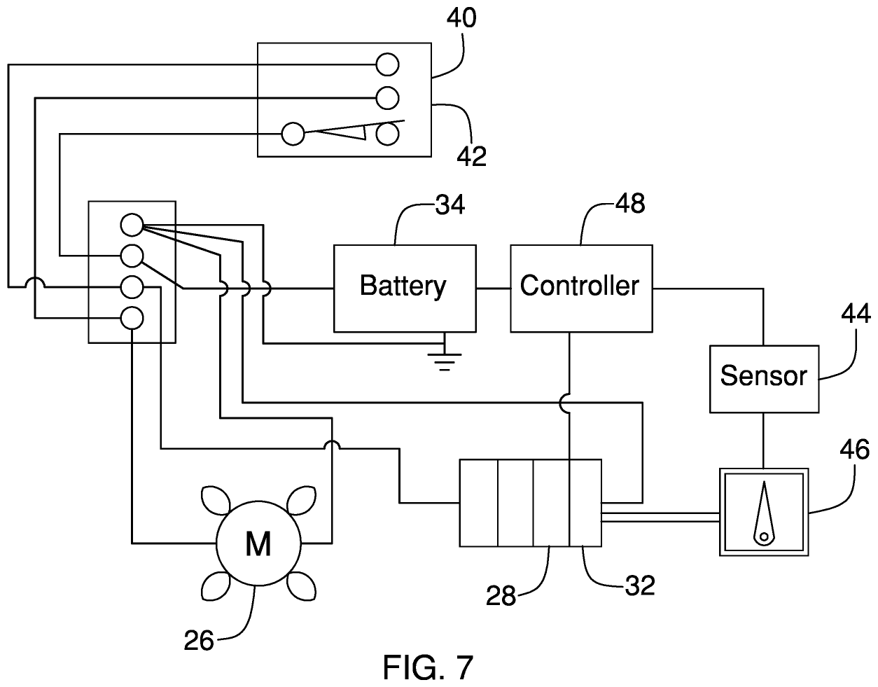

The switch 40 may comprise a two position trigger 42, which is attached to the handle 18 distal from the housing 12, as shown in FIG. 6. The two position trigger 42 is selectively positionable in a first position, to selectively actuate the blower 26, and a second position, to selectively actuate the blower 26 concurrently with the heater 28, as shown in the block diagram of FIG. 7. The present invention anticipates other switching means for selectively actuating the heater 28 and the blower 26, such as, but not limited to, separate switches for each of the heater 28 and the blower 26.

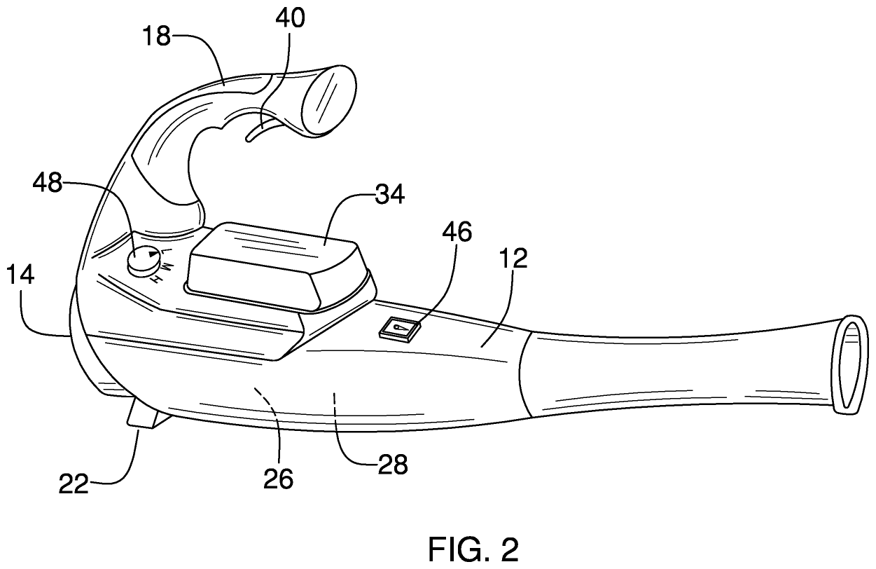

A sensor 44, which is attached to and positioned in the housing 12 between the heater 28 and the outlet port 16, is configured to measure a temperature of the air that passes through the housing 12. A gauge 46 is attached to the housing 12 and is operationally engaged to the sensor 44. The gauge 46 is enabled to display a temperature reading that is measured by the sensor 44. The gauge 46 may be of a simple dial type, as shown in FIG. 2, or of other types, such as, but not limited to, digital type, bar type, and the like.

A controller 48 is attached to the housing 12 and is operationally engaged to the battery 34, the sensor 44, and the heater 28. The controller 48 is enabled to control a temperature of the air passing through the housing 12 by adjusting power that is supplied to the heater 28 by the battery 34.

In use, the air blowing and heating device 10 enables a method 50 to selectively blow debris and to melt frozen water. The method 50 comprises a first step 52 of providing an air blowing and heating device 10 according to the specification above. A second step 54 of the method 50 is attaching the battery 34 to the housing 12. A third step 56 of the method 50 is selectively actuating the switch 40 to generate unheated forced air and heated forced air to blow debris and to melt frozen water, respectively. The air blowing and heating device 10 thus is useful year-round. During warmer seasons, the air blowing and heating device 10 can be used in fulfilling simple blowing functions, such as blowing leaves, grass clippings and the like. During colder seasons, the air blowing and heating device 10 can be used in maintain walkways, driveways, and the like by melting snow and ice. The air blowing and heating device 10 also could be useful in removing snow and ice from other surfaces, such as the surfaces of a vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An air blowing and heating device comprising:
a housing, the housing being tubular, the housing being open ended defining an intake port and an outlet port;
a blower attached to and positioned in the housing, the blower being configured for selectively forcing air through the outlet port;
a heater attached to and positioned in the housing, the heater being configured for selectively heating the air passing through the housing;
a battery selectively attachable to the housing, such that the battery is operationally engaged to the blower and the heater; and
a switch attached to the housing and being operationally engaged to the battery, the heater, and the blower, wherein the switch is configured for being switched for selectively actuating the blower, for generating unheated forced air, and the blower and the heater for generating heated forced air.

2. The air blowing and heating device of claim 1, further including a handle attached to a top of the housing proximate to the intake port, the handle extending arcuately from the housing toward the outlet port.

3. The air blowing and heating device of claim 1, further including a foot attached to a bottom of the housing proximate to the intake port, wherein the foot is configured for stabilizing the housing on a surface.

4. The air blowing and heating device of claim 1, further including a grate attached to the housing and extending over the intake port, wherein the grate is configured for excluding objects from the air entering through the intake port.

5. The air blowing and heating device of claim 1, wherein the heater comprises a gridded heating element.

6. The air blowing and heating device of claim 1, wherein the battery is rechargeable.

7. The air blowing and heating device of claim 1, further including:
a receptacle attached to the housing; and
a plug attached to the battery, the plug being complementary to the receptacle, such that the plug is positioned for insertion into the receptacle for attaching the battery to the housing and for operationally engaging the battery to the blower and the heater.

8. The air blowing and heating device of claim 7, wherein the receptacle is positioned on the top of the housing proximate to the handle.

9. The air blowing and heating device of claim 2, wherein the switch comprises a two position trigger attached to the handle distal from the housing, such that the two position trigger is selectively positionable in a first position for selectively actuating the blower and a second position for selectively actuating the blower concurrently with the heater.

10. The air blowing and heating device of claim 1, further including:
a sensor attached to and positioned in the housing being positioned between the heater and the outlet port, the sensor being configured for measuring a temperature of the air passing through the housing; and
a gauge attached to the housing and operationally engaged to the sensor, such that the gauge is enabled for displaying a temperature reading measured by the sensor.

11. The air blowing and heating device of claim 10, further including a controller attached to the housing and operationally engaged to the battery, the sensor, and the heater, such that the controller is enabled for controlling a temperature of the air passing through the housing by adjusting power supplied to the heater by the battery.

12. A method for selectively blowing debris and melting frozen water, the method comprising the steps of:
providing an air blowing and heating device comprising:
a housing, the housing being tubular, the housing being open ended defining an intake port and an outlet port,
a blower attached to and positioned in the housing, the blower being configured for selectively forcing air through the outlet port,
a heater attached to and positioned in the housing, the heater being configured for selectively heating the air passing through the housing,
a battery selectively attachable to the housing, such that the battery is operationally engaged to the blower and the heater, and
a switch attached to the housing and being operationally engaged to the battery, the heater, and the blower, wherein the switch is configured for being switched for selectively actuating the blower, for generating unheated forced air, and the blower and the heater for generating heated forced air;
attaching the battery to the housing; and
selectively actuating the switch for generating unheated forced air and heated forced air for blowing debris and for melting frozen water, respectively.

13. An air blowing and heating device comprising:
a housing, the housing being tubular, the housing being open ended defining an intake port and an outlet port;
a handle attached to a top of the housing proximate to the intake port, the handle extending arcuately from the housing toward the outlet port;
a foot attached to a bottom of the housing proximate to the intake port, wherein the foot is configured for stabilizing the housing on a surface;
a blower attached to and positioned in the housing, the blower being configured for selectively forcing air through the outlet port;
a grate attached to the housing and extending over the intake port, wherein the grate is configured for excluding objects from the air entering through the intake port;
a heater attached to and positioned in the housing, the heater being configured for selectively heating the air passing through the housing, the heater comprising a gridded heating element;
a battery selectively attachable to the housing, such that the battery is operationally engaged to the blower and the heater, the battery being rechargeable;
a receptacle attached to the housing, the receptacle being positioned on the top of the housing proximate to the handle;
a plug attached to the battery, the plug being complementary to the receptacle, such that the plug is positioned for insertion into the receptacle for attaching the battery to the housing and for operationally engaging the battery to the blower and the heater;
a switch attached to the housing and being operationally engaged to the battery, the heater, and the blower, wherein the switch is configured for being switched for selectively actuating the blower, for generating unheated forced air, and the blower and the heater for generating heated forced air, the switch comprising a two position trigger attached to the handle distal from the housing, such that the two position trigger is selectively positionable in a first position for selectively actuating the blower and a second position for selectively actuating the blower concurrently with the heater;
a sensor attached to and positioned in the housing being positioned between the heater and the outlet port, the sensor being configured for measuring a temperature of the air passing through the housing;
a gauge attached to the housing and operationally engaged to the sensor, such that the gauge is enabled for displaying a temperature reading measured by the sensor; and
a controller attached to the housing and operationally engaged to the battery, the sensor, and the heater, such that the controller is enabled for controlling a temperature of the air passing through the housing by adjusting power supplied to the heater by the battery.
